(19) United States
(12) Patent Application Publication
(10) Pub. No.: US 2012/0030723 A1
(43) Pub. Date: Feb. 2, 2012

(54) METHOD AND APPARATUS FOR STREAMING VIDEO

(75) Inventors: Kevin L. Baum, Rolling Meadows, IL (US); Jeffrey D. Bonta, Arlington Heights, IL (US); George Calcev, Hoffman Estates, IL (US); Benedito J. Fonseca, JR., Glen Ellyn, IL (US)

(73) Assignee: MOTOROLA, INC., Schaumburg, IL (US)

(21) Appl. No.: 12/843,930

(22) Filed: Jul. 27, 2010

(51) Int. Cl. H04N 7/173

(52) U.S. Cl. 725/105

(57) ABSTRACT

A method and apparatus for transmitting video is provided herein. A video representation is segmented into video chunks, with each chunk spanning a different time interval. Each chunk may be divided into two or more sub-chunks. During operation, the client requests a sub-chunk of a particular video chunk and then possibly requests an additional sub-chunk of the video chunk. The client then combines and decodes the sub-chunks to provide a reconstructed video chunk for playback on a device. In an embodiment, I-frames of a video chunk are made available in a separate sub-chunk file than P-frames (or B-frames).

### FIELD OF THE INVENTION

The present invention relates generally to a method and apparatus for streaming video and in particular, to a method and apparatus for transmitting video using HyperText Transfer Protocol (HTTP).

### BACKGROUND OF THE INVENTION

In HTTP Adaptive Streaming, a server provides multiple copies of the same media presentation, each encoded at a different bit rate. However, the number of rates provided is limited and may have been chosen with a different use case scenario than is actually being used by a current client. This can lead to freezes during playback or large video quality gaps between adjacent supported bit rates.

For example, the lowest provided rate might be 250 kbps but a cellular wireless channel cannot always support this rate. This illustrates that the lowest rate provided by an HTTP adaptive streaming server may still be too high for corner-cases of bad wireless coverage. In another example, the server may provide rates such as 64 kbps (with the cellular case in mind), 250 kbps, 500 kbps, and 800 kbps. In this case, there is a large gap in quality between the lowest rate and the next highest rate.

A possible solution would be to greatly increase the number of supported rates at the server. But an issue with this approach includes a greatly increased demand on the transcoders that prepare the media, especially for live programs. As a result, there is a need for a method and apparatus for transmitting video that supports rates below a minimum provided by the server, and for additional rates that are between two adjacent rates provided by the server.

### BRIEF DESCRIPTION OF THE DRAWINGS

FIG. 1 is a block diagram of a server.

FIG. 2 is a block diagram of a client.

FIG. 3 is a flow chart showing operation of the server.

FIG. 4 is a flow chart showing operation of the client.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to alleviate the above-mentioned need, a method and apparatus for transmitting video is provided herein. A video representation is segmented into video chunks, with each chunk spanning a different time interval. Each chunk may be divided into two or more sub-chunks. For example, a sub-chunk may contain video frames of a certain type. A sub-chunk may also contain audio frame data in addition to the video frames. During operation, the client requests a sub-chunk of a particular video chunk and then possibly requests an additional sub-chunk of the video chunk. The client then combines and decodes the sub-chunks to provide a reconstructed video chunk for playback on a device

As part of this solution, the file structure of the chunk files may be reorganized on the server so that the client can take over the responsibility for deciding which sub-chunks to request, while the server can still be a relatively simple HTTP file server. More particularly, in an embodiment, I-frames of a video chunk are made available in a separate sub-chunk file than P-frames (or B-frames). The sub-chunks may be encapsulated in a container file that the server manages, such as an MPEG-2 Transport Stream container or in an MPEG-4 container.

Such organization allows the following functionality: the client requests the download of the I-frames of video chunk k first (by requesting an I-frame sub-chunk file for video chunk k), and then decides whether it has sufficient time to request/download the P and/or B-frames of chunk k. For example, if proceeding with the download of the P-frames of chunk k would cause the video playback to freeze (buffer underflow), there is insufficient bandwidth to download the P or B-frames. In this situation, the client can just playback the already downloaded I-frames, not request the P or B-frames of chunk k, and instead request the I-frames of the next video chunk, k+1. Of course, in situations where the client has high confidence that there is sufficient time to download both the I- and P or B-frames of chunk k, the I- and P or B-frames could be requested/delivered in any order.

Because I-frames for a chunk of video are downloaded prior to P or B-frames, the client is in full control of determining which frames are actually downloaded, and can change its requested frame types and hence its video rate on a chunk by chunk basis. During this process, the HTTP file server simply supplies the requested I-frames and P-frames in the form of sub-chunks as they are requested by the client.

The present invention encompasses a method for streaming video. The method comprises the steps of requesting a first sub-chunk of video, wherein the first sub-chunk of video comprises one or more video frames of at least a first type, requesting a second sub-chunk of video, wherein the second sub-chunk of video comprises one or more video frames of only a second type, and receiving the first and the second sub-chunk of video. The video is assembled by combining the first sub-chunk and the second sub-chunk of video.

The present invention encompasses a method comprising the steps of determining an amount of bandwidth available and requesting a sub-chunk of video to be transmitted based on the amount of bandwidth available, wherein video frames in the sub-chunk requested comprise only predicted frames.

The present invention additionally encompasses an apparatus comprising a transceiver requesting a first sub-chunk of video, wherein the first sub-chunk of video comprises one or more video frames of at least a first type, the transceiver requesting a second sub-chunk of video, wherein the second sub-chunk of video comprises one or more video frames of only a second type, the transceiver receiving the first and the second sub-chunk of video. A combiner is provided for assembling the video by combining the first sub-chunk and the second sub-chunk of video.

Prior-art HTTP Adaptive Streaming operates on the principle that a video is segmented into small chunks that are independently downloaded from the server as requested by the client. The chunks can be transcoded into a predetermined set of different bit rates to enable adaptation to the available bandwidth of the channel over which the chunks are downloaded. The client determines the available channel bandwidth and decides which chunk bit rate to download in order to match the available bandwidth.

HTTP Adaptive Streaming video formats represent each picture of the video with a frame. Different frames can have differing importance for reconstructing the video. For H.264 (or MPEG-4 Part 10), there are I-frames, P-frames, and B-frames. P-frames and B-frames are both predicted frames (thus the term “predicted frames” may refer to either P-frames, or B-frames, or a combination of P-frames and B-frames), but P-frames are based on unidirectional predictions while B-frames are based on bi-directional prediction. These frames may be further broken down into slices. A slice is a spatially distinct region of a picture that is encoded separately from any other region in the same picture and may be referred to as I-slices, P-slices, and B-slices.

Note that in the description of the present invention, the term “frame” may also refer to a slice or a collection of slices in a single picture. I-frames are reference pictures and are therefore of highest importance. P frames provide enhancements to the I-frame video quality and B frames provide enhancements to the video quality over and above the enhancements provided by P frames. P and B frames have less importance than I frames and are typically much smaller in size than the corresponding I-frame. As a consequence, it is possible to drop P and/or B frames to reduce bandwidth requirements without destroying the ability to render the video in the media player. However, frame dropping by the server is problematic for HTTP adaptive streaming because the transport is based on TCP, which would try to recover any missing file fragments and stall the download if frames are dynamically dropped by the server in the middle of a video chunk download. Hence, by creating sub-chunks of I, P, and B frames, the client device is able to request one or more sub-chunks of a video chunk without creating a problem for the TCP transport.

Prior-art HTTP Adaptive Streaming video chunks typically have a duration of a few seconds and an internal form like ({IPPP- . . . P} {IPP . . . P} . . . {IPPP . . . P}] where I=I-frame (e.g., key frame, or independently decodable reference frame), P=predicted frame, and { } represents a group of pictures (GOP). This format is applicable for the H.264 Baseline Profile, which is the highest profile supported by most handheld devices (cellphones., PDA's, etc.). Higher profiles can add an additional frame type: the bi-directional predicted frame (B-frame), in addition to I and P frames.

Unlike the prior art, a video chunk is represented by sub-chunks. For example, a single video chunk is represented by two sub-chunk files: 1) an I-frame file (called I-file) and, 2) a P-frame file (called P-file). It should be noted that when B-frames are being utilized, the B-frame file will be referred to as a B-file. In the simplest case of complete separation, and where I and P frames are only being utilized, the P-file does not contain any I-frames. The I- and P-files can be prepared ahead of time by an encoder or encoder post-processor, and then simply stored on an HTTP server or an internet Content Delivery Network (CDN). The files are compatible with various caching schemes and hierarchical CDN's, etc.

Where only I and P frames are being utilized, the client is aware of the new sub-chunk file structure and operates as follows:
The client requests the I-file first. Then, if there is sufficient time remaining, the client requests the P-file.
If there is insufficient time to download the P-file, the client can skip the P-file download and move on to the next I-file download (e.g., for a video chunk that is further into the future).
If the client requests a P-file, and then determines it cannot finish the download in time (e.g., due to a sudden drop in channel throughput), it can abort the P-file download midstream in order to save network capacity.
The client combines the I-file and P-file sub-chunks. This can be accomplished by reassembling the I-file and P-file (if available) into a single video stream to recreate the original video stream. If the P-file is not available, the client can decode and play just the I-file. If a partial P-file is available, its contents can be re-multiplexed with the I-file to create a partially reconstructed video stream. Thus, the client reconstructs and decodes/plays a video chunk based on either the I-file, or the combination of the I-file and the P-file, or a combination of at least portions of the I- and P-files.

The original, complete video chunk file (containing the I and P frames in their original order) can optionally also be stored and be made available on the HTTP server. This not only allows for backward compatibility to clients that do not support the sub-chunk requesting/combining of the present invention, but also increases the efficiency in the download process. If the conditions of the channel are good enough, the client may decide to directly request the original, complete video chunk file rather than requesting sub-chunks, thus saving the energy and processing power that would have been used to combine separately downloaded sub-chunks.

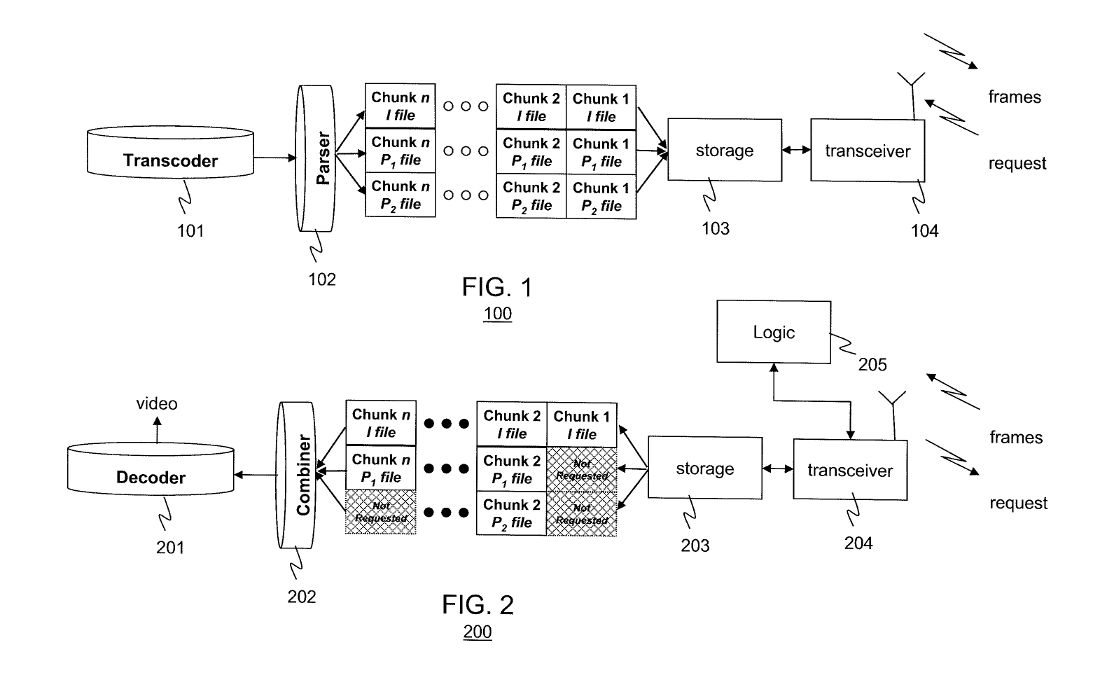

Turning now to the drawings, where like numerals designate like components, FIG. 1 is a block diagram showing server 100. As shown, server 100 comprises transcoder 101, parser 102, storage 103, and transceiver 104. Transcoder 101 comprises a standard video transcoder or encoder that outputs compressed video frames. Particularly transcoder 101 comprises circuitry that outputs at least two picture types, namely I and P frames. As one of ordinary skill in the art will recognize, I-frames are the least compressible but don't require other video frames to decode. P-frames are predicted and use data from previous frames (unidirectional prediction) to decompress and are more compressible than I-frames. Transcoder 101 may also output a third picture type, namely B-frames, which are also predicted, but the prediction is performed in a bi-directional manner.

Parser 102 comprises circuitry that reorganizes the I-frames and P-frames output from transcoder 101. (B-frames may be reorganized by parser 102 if they are utilized). More particularly, for each temporal chunk of video, parser 102 organizes sub-chunks of I-frames and sub-chunks of P-frames for the chunk of video. A single chunk of video preferably spans a time duration of a small number of seconds (e.g., typically from 2 to 10 seconds). Storage 103 comprises standard random access memory and is used to store I and P sub-chunks.

Finally, transceiver 104 comprises common circuitry known in the art for communication utilizing a well known communication protocol, and serve as means for transmitting and receiving video. Such protocols include, but are not limited to IEEE 802.16, 3GPP LTE, 3GPP WCDMA, Bluetooth, IEEE 802.11, or HyperLAN protocols.

During operation server 100 receives a request for a first sub-chunk of video, wherein the first sub-chunk of video comprises video frames of at least a first type and then receives a request for a second sub-chunk of video, wherein the second sub-chunk of video comprises video frames of only a second type. If additional sub-chunks are available on server 100 for a particular chunk of video (e.g., a P₂ sub-chunk file for video chunk n in FIG. 1), they may also be requested by a client device in addition to the first and second sub-chunks. The request for a sub-chunk is preferably based on an HTTP GET command. In response to the requests, server 100 transmits the sub-chunks to the requester, preferably over a TCP connection. As discussed, preferably the first and the second frame type comprises I and P type frames. However, if B frames are being utilized, the second frame type may comprise any predicted frame (P or B frames).

FIG. 2 is a block diagram of a client device 200. As shown, client device 200 comprises decoder 201, combiner 202, storage 203, and transceiver 204. Decoder 201 comprises a standard video decoder that receives I and P type frames, and possibly B frames, and outputs a decoded video stream. Combiner 202 comprises circuitry that combines or reorganizes a sub-chunk of I-frames and a sub-chunk of P-frames output from storage 203 into a mixed I and P chunk of video. (When B-frames are being utilized, combiner 202 may combine B-frames as well).

Storage 203 comprises standard random access memory and is used to store I, P, and B sub-chunks. For a particular chunk of video, the client device may request only a first sub-chunk (e.g., for video chunk 1 of FIG. 2), or a first and second sub-chunk (e.g., for video chunk n of FIG. 2), and so forth. Only the sub-chunks actually obtained based on the client device requests will be available to combiner 202. Transceiver 204 comprises common circuitry known in the art for communication utilizing a well known communication protocol, and serve as means for transmitting and receiving video. Such protocols include, but are not limited to IEEE 802.16, 3GPP LTE, 3GPP WCDMA, Bluetooth, IEEE 802.11, or HyperLAN protocols. Finally, logic circuitry 205 comprises a digital signal processor (DSP), general purpose microprocessor, a programmable logic device, or application specific integrated circuit (ASIC) and is utilized to determine available bandwidth by accessing transceiver 204, and instructing transceiver 204 to appropriately request sub-chunks of I-frames and P-frames from HTTP server 100.

During operation, logic circuitry 205 will instruct transceiver 204 to request a first sub-chunk of video, wherein the first sub-chunk of video comprises video frames of at least a first type (e.g., I-frames). A determination will then be made by logic circuitry 205 if bandwidth is available for requesting a second sub-chunk of video, and if so, logic circuitry 205 will instruct transceiver 204 to request a second sub-chunk of video, wherein the second sub-chunk of video comprises video frames of only a second type (e.g., predictive frames (P and/or B)). It should be noted that the first and the second sub-chunks of video represent an overlapping time period for the video, and are not sequential in time.

Regardless of whether or not a sub-chunk of P or B-frames were requested, the sub-chunks that were downloaded for a particular video are stored in storage 203 and available for combiner 202. Combiner 202 simply reorganizes the sub-chunks of I frames and P/B-frames (if available) into a combined sequence or video chunk recognized by decoder 201. Decoder 201 then takes the chunk and outputs a decoded video stream.

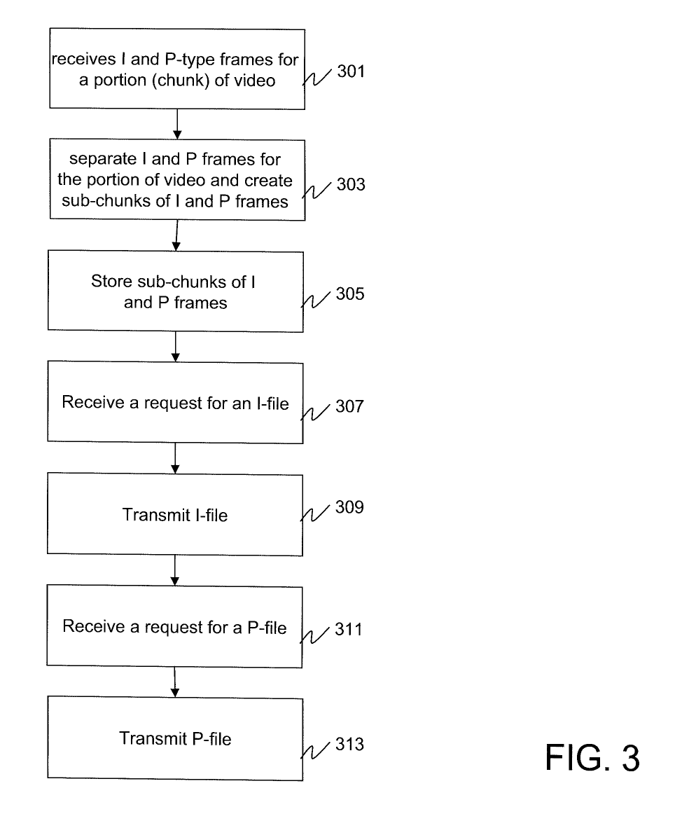

FIG. 3 is a flow chart showing operation of server 100 where only I and P-type frames are being used. At step 301, parser 102 receives I and P-type frames for a portion (chunk) of video. Parser 102 then separates I and P frames for the portion of video and creates sub-chunks of I and P frames (step 303). At step 305 the sub-chunks of I and P frames (e.g., I-files and P-files) are stored in storage 103. At step 307, transceiver 104 receives a request for an I-file. As discussed, the video frames of the I-file comprise only I-frames. In response, the requested I-file is transmitted via transceiver 104 to the requester (step 309). Transceiver 104 then receives a request for a P-file (or a PB file if both P and B-frames are being used) (step 311). As discussed, the video frames of the P-file comprise only P-frames. If B-frames are being utilized, the PB-file contains P-frames and B-frames. In response to the requests, transceiver 104 transmits the P-file to the requester (step 313).

As mentioned above, when no B-frames are being utilized, the video frames of the I-file and P-file transmitted to the requester comprise only I frames and P frames, respectively. The I-frames and the P-frames are frames of video taken over a certain overlapping time period (e.g., 10 seconds). Hence, I-frames within the I-file represent frames taken from the same 10 seconds of video as the P-frames within the P-file.

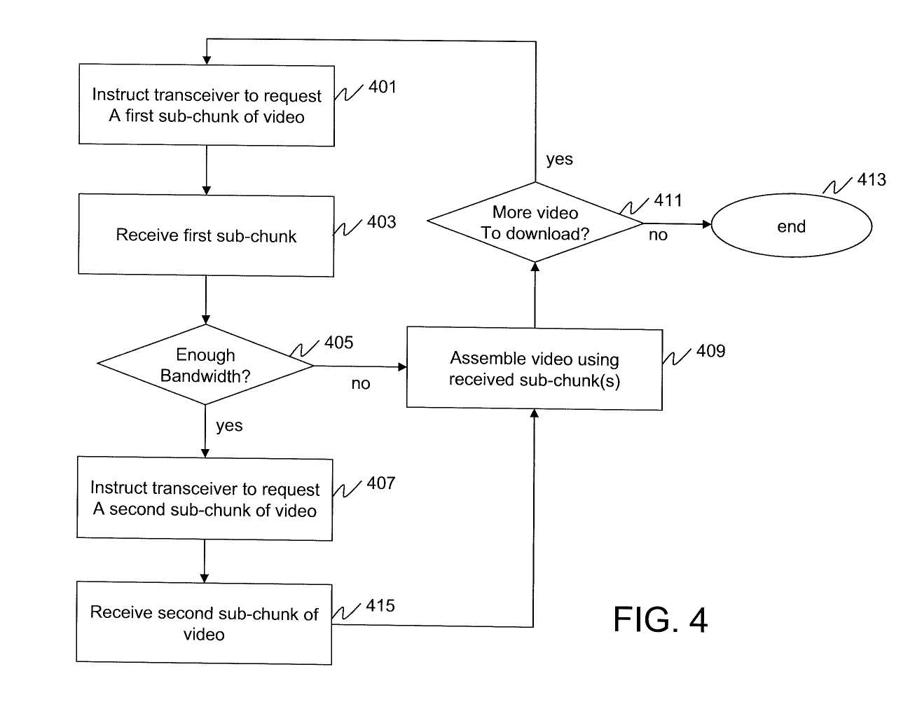

FIG. 4 is a flow chart showing operation of client 200 when only I- and P-frames are being used. The logic flow begins at step 401 where logic circuitry 205 instructs transceiver 204 to request a first sub-chunk of video comprising one or more video frames of at least a first type. The step of requesting the first sub-chunk of video is preferably made using an HTTP GET request. At step 401 transceiver 204 may request an I-file from server 100 comprising one or more I-frames (and possibly predicted frames as well). Preferably, the video frames of the I-file comprise only I-frames.

At step 403, transceiver receives the first sub-chunk of video (I-file). The step of receiving preferably comprises receiving over a TCP connection. At step 405, logic circuitry 205 then determines if enough bandwidth exists to request the corresponding P-file (or PB file if B frames are being utilized). This is preferably accomplished by the following process: estimating the time needed to download the P-file, adding to this the time already taken to download the I-file to get a total estimated chunk download time, and then comparing the total estimated chunk download time to a time threshold. If the total estimated chunk download time is less than the threshold, then enough bandwidth exists to download the P-file. Otherwise, there may not be enough bandwidth and the P-file should not be requested, or it could be requested with the knowledge that it will only be partially received and the download of the P-file may need to be cancelled/terminated prior to receiving the entire P-file.

The value of the time threshold may be based on the time duration of the video represented by the chunk, and may also be influenced by the amount of video that is presently buffered by the client. For example, if only one previous video chunk has been buffered by the client, the threshold value may be set to be equal or somewhat smaller than the time duration of the video chunk so that the download of the P-file will likely finish before the playback of the previous buffered chunk completes (thus avoiding a “freeze” in the playback of the video stream). If several previous chunks of video have been buffered, the threshold value can either be set to approximately the chunk duration (a choice which would approximately maintain the buffer state) or somewhat larger than the chunk duration (a choice that would partly drain the buffer but still avoid a “freeze” in the video stream playback on the client device). Also note that the time needed to download the P-file can be estimated based on the size or estimated size of the P-file and the estimated data rate or throughput available to the client for downloading the P-file.

If, at step 405 it is determined that enough bandwidth exists for the P-file to be requested, then logic circuitry instructs transceiver 204 to request a second sub-chunk of video, wherein the second sub-chunk of video comprises one or more video frames only of a second type (e.g. only predicted frames which may comprise a P-file containing only P frames, a B-file containing only B frames, or a PB-file containing predicted frames of both B-frames and P frames) (step 407). The second sub-chunk of video is received by transceiver 204 (step 415) and the logic flow continues to 409 where the video is assembled by combining the first sub-chunk and the second sub-chunk of video.

If not enough bandwidth is available at step 405, the logic flow continues to step 409 where combiner 202 assembles the video from only the I frames. The logic flow then continues to step 411 where logic circuitry 205 determines if more video (e.g., additional video chunks for future time intervals) is to be downloaded. If, at step 411, it is determined that more video is to be downloaded, the logic flow returns to step 401, otherwise the logic flow ends at step 413 where the first and possibly the second sub-chunk of video are received and assembled by combining the first and the second sub-junks of video.

It should be noted that the first and the second sub-chunk of video represent an overlapping time period of video and that at least one of the video sub-chunks can comprise audio data. Additionally metadata may be received by transceiver 204 containing information that can be used to assist in determining how to combine the first and second sub-chunks. Additionally, only a portion of the second sub-chunk of video may be received. When this happens, the step of assembling the video by combining the first sub-chunk and the second sub-chunk of video comprises the step of combining at least part of the obtained portion of the second sub-chunk of video with the first sub-chunk of video. Finally, although the above flow chart shows the first and the second sub-chunks of video being separately requested, it should be noted that the first and second sub-chunks may be requested by a single request, and that the single request may be cancelled before the second sub-chunk is fully received (based on bandwidth availability).

While the invention has been particularly shown and described with reference to a particular embodiment, it will be understood by those skilled in the art that various changes in form and details may be made therein without departing from the spirit and scope of the invention. For example, for clarity of explanation, the invention is described primarily for the case of the Baseline profile, with the understanding that the invention is also applicable/extensible to higher profiles containing B-frames and/or small-scale frame order permutations. In addition, the following paragraphs give changes to the above-described system that may be implemented, and the applicability/extensibility to B-frames applies to the following paragraphs as well. It is intended that such changes come within the scope of the claims.

As an alternative to the separate I and P sub-chunk files, a chunk can be represented by a single file (called an IP-file), but the file structure is organized such that the I-frames occur closer to the beginning of the file, rather than uniformly distributed over the file.
The IP-file may look like ((II . . . I)(PP . . . P)). The (II . . . I) portion of the file may be referred to as first sub-chunk, and the (PP . . . P) portion a second sub-chunk.
The client requests the first and second sub-chunks by requesting the IP-file. However, the client can abort the download of the IP-file at any time after the I-frames have been acquired.
The client reassembles the I-frames and P-frames (if available) into a single video stream to recreate, either partially or completely, the original video stream. If the P-frames are not available, the client can play just the I-frames. If only a portion of the P-frames are available, they can be re-multiplexed with the I-frames to create a partially reconstructed video stream.
The client can request a sub-chunk of I-frames or P-frames by making a byte-range restricted request for the IP-file. For example, if the I-frames of the IP-file are within bytes 0-1762, and the P-frames are within bytes 1763-2200, the client can request a sub-chunk of I-frames by requesting only bytes 0-1762 of the IP-file (e.g., using an HTTP GET request for the IP-file that specifies a limited byte range rather than the entire IP-file). Byte-range restricted requests may also be used to request sub-chunks or portions of sub-chunks in other embodiments of the invention.

### Multiple I-Files

Instead of a single I-file sub-chunk per video chunk, the I-frames can be de-interlaced into multiple sub-chunk I-files, preferably by decimating the I frames with multiple decimation offsets. Let a set of I frames for a video chunk be denoted as (I1 I2 I3 I4 I5 I6 I7 I8 I9 I10 I11 I12). Then we could create two I-file sub-chunks for the video chunk: I-file[1] containing (I1 I3 I5 I7 I9 I11) and I-file[2] containing (I2 I4 I6 I8 I10 I12).

The client can request I-file[1] first and then decide whether to request I-file[2]. In this case, downloading I-file[2] doubles the frame rate of the video if the video playback only uses I-frames.

Alternatively, multiple I-files can be created with a decreasing number of I-frames. For example, I-file[1,1] contains all the I-frames of the chunk, I-file[1,2] contains ½ of the I-frames of chunk, I-file[1,3] contains ⅓ of the I-frames of the chunk, I-file[1,4] contains ¼ of the I-frames and so forth. In this alternative, the corresponding P-files P-file[1,2], P-file[1,3], P-file[1,4] would only contain the P-frames that follow the I-frames contained within the corresponding I-files.

Within this alternative, optionally, it is possible to create additional I-files that contain a higher number of I-frames than the originally encoded chunk. For example, consider a 15 fps video sequence in which 10-second chunks would contain 12 I-frames and 138 P-frames. An additional I-file[i,j] with i*j I-frames could be created. In this option, the corresponding P-file[i,j] would contain P-frames that are to follow the I-frames contained in the I-file[i,j]. The benefit of this option is that it would allow further alternatives for a client in a situation in which the I-file (i.e. I-file[1,1]) is too short for the allowed download time but the I-file-+P-file is too long for the allowed download time.

### Multiple P-Files

Instead of a single P-file sub-chunk per video chunk, the P-frames can be de-interlaced into multiple sub-chunk P-files. In this scenario it is preferred that the P-frame dependencies have been pre-set by the encoder to be hierarchical in nature. For example, odd-numbered P-frames in a GOP depend only on the I-frame and/or other odd-numbered P-frames in the GOP. Then the even-numbered P-frames can depend on any frames (I and/or P) within the GOP. Let set of P frames satisfying the specified hierarchical dependency for a video chunk be denoted as (P1 P2 P3 P4 P5 P6 P7 P8 P9 P10 P11 P12). Then we could create two sub-chunk P-files for the video chunk: P-file[1] containing (P1 P3 P5 P7 P9 P11) and P-file[2] containing (P2 P4 P6 P8 P10 P12).

The client can request P-file[1] first and then decide whether to request P-file[2]. In this case, downloading P-file[2] increases the frame rate of the video.

The multiple sub-chunk I-file and multiple sub-chunk P-file concepts can of course be combined in various permutations, such as I-file[1]I-file[2] P-file[1] P-file[2], or I-file[1] P-file[1] I-file[2] P-file[2], etc.

### Limited Mixing of I and P Frames

This variation is to allow some P-frames to be multiplexed with the I-frames in a single sub-chunk, but still keep a significant portion of the P-frames in a separate sub-chunk (or at the end of the file in the single-file variation such as ((IPIPIP . . . IP)(PPP . . . P)). This could be useful when the video stream has hierarchical P-frames—the most important P-frames could be interleaved with I-frames in a first sub-chunk, and the remaining P-frames would be in a second sub-chunk. Or the most important hierarchical P-frames (labeled as Ph in this example for clarity) could be put into the same sub-chunk as the I-frames, with remaining P-frames placed in a second sub-chunk. In the case of a single file containing all of the sub-chunks, the Ph frames could be put at the beginning of the P-frame section like ((III . . . I)(PhPhPh . . . )(PPP . . . P)), or could be interlaced with the I-frames like ((IPhIPhIPh . . . IPh)(PPP . . . P)).

### Audio Track Considerations

The audio track can be multiplexed with the I-file as audio data, or be kept in a separate audio file. It may be downloaded before P-files and possibly before the I-file if maintaining the audio portion of the program during bad conditions is more important than the video portion.

### Additional Examples of a Frame Type

In various embodiments of the invention, some additional examples of a frame type are as follows:
A predicted frame that is hierarchically predicted (e.g., hierarchically predicted B-frame and/or hierarchically predicted P-frame)
A frame that is not predicted
A frame that is selected from a set of frames based on a predetermined frame selection/decimation scheme. For example, an I-frame obtained by selecting only every second I-frame from a set of I-frames.

### Scalable Coding

A scalable video coder or transcoder, such as one based on H.264 SVC, can generate a base layer video and one or more enhancement layers for the video. The video can be reconstructed at lower fidelity by decoding only the base layer, or at higher fidelity by combining the base layer with one or more enhancement layers. Using a scalable video coder/transcoder in the present invention, a video chunk may be divided into two or more sub-chunks, such as a first video sub-chunk comprising the base layer and a second sub-chunk comprising an enhancement layer. For example, Transcoder 101 of FIG. 1 may be a scalable video transcoder if it is converting non-scalable video to scalable video or a scalable video encoder if it is an original source of digital video content, and the files for a given chunk in FIG. 1 can be sub-chunks for different layers of the scalable video (e.g., base layer sub-chunk, enhancement layer sub-chunk, second enhancement layer sub-chunk). Alternatively, the first sub-chunk may contain all frames of a base layer and a portion of the enhancement layer (e.g. some predicted frames), while the remaining portion of the enhancement layer would be present in the second sub-chunk. A client can request the first sub-chunk, and then if there is sufficient bandwidth available, it can request the second sub-chunk. To determine if sufficient bandwidth is available, a process similar to the one described for FIG. 4 can be used, but for the base layer sub-chunk and enhancement layer sub-chunk. If the client requests both the first sub-chunk and the second sub-chunk, the client can then combine the first and second sub-chunks into a decoded video sequence for the video chunk. If only a portion of the second sub-chunk is obtained, the client can combine the first sub-chunk and the obtained portion of the second sub-chunk. If there is more than one enhancement layer, combining the first and second sub-chunks into a decoded video sequence for the video chunk may include combining an additional enhancement layer/layers that were obtained by the client.

### Video Stream Reassembly at the Client

Combining the video chunks is simple if the frame rate and GOP (group of picture size or key frame interval) are fixed, as recommended by the current HTTP adaptive streaming proposals. In this case the client implicitly knows the number of frames per GOP (say 20), number of P-frames per GOP (20−1=19 in this example), and the order that they need to be re-multiplexed. So, the client knows that for every I-frame pulled out of the I-file, it needs to pull the next 19 P-frames out of the P-file.

If the I-frame interval varies, a solution to coordinate the reassembly of the video stream in the client is the following: Each I-file may contain a sub-header with N fields, in which N is the number of I-frames in the I-file. The 1st field of the sub-header indicates the number of P-frames (of the associated P-file) that follows the 1st I-frame, the 2nd field of the sub-header indicates the number of P-frames that follows the 2nd I-frame, and so forth (the information of the N-fields could also be compressed (e.g., run-length encoding, differential coding, or other compression schemes)). This same solution is applicable to the scenario in which multiple I-files exist, in which the N fields in the sub-header of the I-file[i,j] would refer to the P-frames of the associated P-file[i,j]. The same solution is available for the case in which hierarchical P-frames are used. In this case, the P-file in a first level of hierarchy would contain a sub-header that indicates how many of the P-frames in the P-file in a second level of hierarchy should follow each P-frame in the P-file. This solution is one example of a method for providing metadata to the client, where the metadata includes information that helps the client determine how to combine multiple sub-chunks of video. Other embodiments of this method are also within the scope of the present invention. For example, HTTP adaptive streaming servers usually have a playlist file or a manifest file that specifies the filenames or Uniform Resource Indicators (URIs) for all of the video chunk files that make up the video stream/media presentation. Information can be added to this playlist/manifest file to assist the client in combining multiple sub-chunks having an overlapping time period. For example, a frame map could be provided, specifying the order and type of frames in the original video sequence. This information could be compressed in various ways or use a combination of implicit and explicit mapping. The client can obtain the metadata either from the sub-chunk file or by requesting a separate file (e.g., playlist/manifest) depending on the implementation.

1. A method for streaming video, the method comprising the steps of:
requesting a first sub-chunk of video, wherein the first sub-chunk of video comprises one or more video frames of at least a first type;
requesting a second sub-chunk of video, wherein the second sub-chunk of video comprises one or more video frames of only a second type;
receiving the first and the second sub-chunk of video; and
assembling the video by combining the first sub-chunk and the second sub-chunk of video.

2. The method of claim 1 wherein the first sub-chunk of video comprises one or more I-frames.

3. The method of claim 1 wherein the second sub-chunk of video comprises one or more predicted frames.

4. The method of claim 3 wherein the predicted frames comprise only P frames, only B frames, or a combination of P and B frames.

5. The method of claim 1 wherein the step of requesting the first sub-chunk of video is made using an HTTP GET request, and wherein the step of receiving comprises receiving over a TCP connection.

6. The method of claim 1 wherein the first and the second sub-chunk of video represent an overlapping time period of video.

7. The method of claim 1 wherein at least one of the video sub-chunks further comprises audio data.

8. The method of claim 1 further comprising the step of:
receiving metadata comprising information that can be used to assist in determining how to combine the first and second sub-chunks.

9. The method of claim 1 wherein only a portion of the second sub-chunk of video is received, and wherein the step of assembling the video by combining the first sub-chunk and the second sub-chunk of video comprises the step of combining at least part of the obtained portion of the second sub-chunk of video with the first sub-chunk of video.

10. The method of claim 1 wherein the first and second sub-chunks are requested by a single request, and further comprising the step of:
cancelling the single request before the second sub-chunk is fully received.

11. The method of claim 1 further comprising the steps of:
determining if sufficient bandwidth is available for requesting the second sub-chunk of video, and
requesting the second sub-chunk of video only when the sufficient bandwidth is available.

12. A method comprising the steps of:
determining an amount of bandwidth available;
requesting a sub-chunk of video to be transmitted based on the amount of bandwidth available, wherein video frames in the sub-chunk requested comprise only predicted frames.

13. The method of claim 12 further comprising the step of:
receiving the sub-chunk of video comprising only predicted frames.

14. The method of claim 12 wherein the predicted frames comprise only P frames.

15. The method of claim 12 wherein the predicted frames comprise only P and B frames.

16. An apparatus for streaming video, the apparatus comprising:
a transceiver requesting a first sub-chunk of video, wherein the first sub-chunk of video comprises one or more video frames of at least a first type, the transceiver requesting a second sub-chunk of video, wherein the second sub-chunk of video comprises one or more video frames of only a second type, the transceiver receiving the first and the second sub-chunk of video; and
a combiner assembling the video by combining the first sub-chunk and the second sub-chunk of video.

17. The apparatus of claim 16 wherein the first sub-chunk of video comprises one or more I-frames.

18. The apparatus of claim 16 wherein the second sub-chunk of video comprises one or more predicted frames.

19. The apparatus of claim 18 wherein the predicted frames comprise only P frames, only B frames, or a combination of P and B frames.

20. The apparatus of claim 16 wherein the first and the second sub-chunk of video represent an overlapping time period of video.
